(19) United States
(12) Patent Application Publication
(10) Pub. No.: US 2009/0056537 A1
(43) Pub. Date: Mar. 5, 2009

(54) Method and Device for the process-integrated hot gas purification of dust and gas components of a synthesis gas

(76) Inventor: Oliver Neumann, Offenbach (DE)

Correspondence Address: Nixon Peabody, 200 Page Mill Road, Suite 200, Palo Alto, CA, 94306, US

(21) Appl. No.: 12/248,887

(22) Filed: Oct. 9, 2008

(30) Foreign Application Priority Data
Apr. 11, 2006 (DE) 10 2006 017 353.8
Mar. 9, 2007 (EP) PCT/EP2007/052257

(51) Int. Cl. B01D 53/12; B01D 53/48; B01D 53/68; B01D 53/02; B01D 53/24

(52) U.S. Cl. 95/35; 95/135; 95/132; 95/115; 96/108; 96/150; 96/118; 95/91

(57) ABSTRACT

Method for the process-integrated gas purification of a synthesis gas, including the following steps:
gasification of the feed in a reactor by the use of pulse heaters;
addition of additives to the reactor or to the gas section downstream of the reactor in order to remove sulphur-containing gas components in order to achieve in-situ removal;
separation of dust content of the synthesis gas in the downstream gas section;
recycling of the dust content separated off to the reactor.

This application is a continuation of App. No. PCT/EP2007/052257 filed Mar. 8, 2007, which claims priority to DE 10 2006 017 353.8 filed Apr. 11, 2006.

### FIELD OF THE INVENTION

The development of thermal gasification methods has produced essentially three different types of gasifier, namely entrained bed gasifiers, fixed bed gasifiers and fluidised bed gasifiers.

Primarily fixed bed gasifiers and fluidised bed gasifiers have been developed further for commercial gasification.

Of the many different technical approaches in the field of fixed bed gasification, the Carbo V method will be described by way of example here.

Relevant literature for fluidised bed gasification, which forms part of this application, is as follows: “High-Temperature Winkler Gasification of Municipal Solid Waste”; Wolfgang Adlhoch, Rheinbraun A G, Hisaaki Sumitomo Heavy Industries, Ltd., Joachim Wolff, Karsten Radtke (speak(er), Krupp Uhde GmbH; Gasification Technology Conference; San Francisco, Calif., USA; Oct. 8-11, 2000; Conference Proceedings.

Relevant literature for circulating fluidised beds in a combined system, which forms part of this application, is as follows: “Dezentrale Strom-und Wärmeerzeugung auf Basis Biomasse-Vergasung”; R. Rauch, H. Hofbauer; Lecture, Uni Leipzig 2004. “Zirkulierende Wirbelschicht, Vergasung mit Luft, Operation Experience with CfB—Technology for Waste Utilisation at a Cement Production Plant” R. Wirthwein, P. Scur, K.-F. Scharf-Rüdersdorfer Zement GmbH, H. Hirschfelder-Lurgi Energie und Entsorgungs GmbH; 7^{th} International Conference on Circulating Fluidized Bed Technologies; Niagara Falls, May 2002.

Relevant literature for combined fixed beds (rotating tube), which forms part of this application, is as follows: 30 MV Carbo V Biomass Gasifier for Municipal CHP; The CHP Project for the City of Aachen, Matthias Rudloff; Lecture, Paris, October 2005.

Relevant literature for combined systems for fixed bed gasification (slag tap gasifier), which forms part of this application, is as follows: Operation Results of the BGL Gasifier at Schwarze Pumpe, Dr. Hans-Joachim Sander SVZ; Dr. Georg Daradimos, Hansjobst Hirsclifelder, Envirotherm; Gasification Technologies 2003; San Francisco, Calif., Oct. 12-15, 2003; Conference Proceedings.

In the Carbo V method, gasification takes place in two stages. The biomass is first split into its volatile and solid constituents at 500° C. A tarry gas and additionally “wood charcoal” are produced. The gas is burnt at temperatures in excess of 1200° C., the tars breaking down to CO₂ and H₂. A product gas containing CO and H₂ is then produced with the hot flue gas and the wood charcoal.

As a result of the high technical complexity and the high costs due to the high pressure level (up to 40 bar), gasifiers of these types are completely unsuitable for the gasification of biomass (which occurs regionally and has a significant influence on the costs for logistics and processing).

Fluidised bed gasifiers can be divided into two methods differing from one another by the heating of the fluidised bed, namely circulating fluidised bed gasifiers and stationary fluidised bed gasifiers.

Relevant literature for desulphurisation in fluidised bed gasification, which forms part of this application, is as follows: Gasification of Lignite and Wood in the Lurgi Circulating Fluidized Bed Gasifier; Research Project 2656-3: Final Report, August 1988, P. Mehrling, H. Vierrath; LURGI GmbH; for Electric Power Research Institute, Palo Alto, Calif.: ZWS-Druckvergasung im Kombiblock, Final Report BMFT FB 03 E 6384-A; P. Mehrling, LURGI GmbH; Bewag.

An allothermal circulating fluidised bed gasification plant was put into operation in Güssing (Austria) at the beginning of 2002. The biomass is gasified in a fluidised bed with steam as an oxidising agent. In order to provide the heat for the gasification process, part of the wood charcoal produced in the fluidised bed is burnt in a second fluidised bed. The gasification under steam produces a product gas. The high initial costs for the plant technology and excessive process control costs have a disadvantageous effect.

One of the crucial problems with all of these approaches is the purification of the off-gases.

### SUMMARY OF THE INVENTION

The invention relates to a method and a device for the process-integrated hot gas purification of dust and gas components of a synthesis gas produced during gasification, in particular during the gasification of biomass.

This problem is solved by an invention having the features of the independent claims.

No other known method is capable of producing a high-quality synthesis gas at unrivalled low cost, as a result of comparatively low investment costs, with CO₂ reduction, or of utilising it as energy and simultaneously processing it into a fuel, after appropriate cooling and purification.

In this invention, the biomass is also gasified in a fluidised bed with steam as an oxidising and fluidising medium, although in this case it is a stationary fluidised bed with two specially developed pulse heaters allowing for the indirect introduction of heat into the fluidised bed situated in the reactor.

The advantage over fixed bed gasifiers and circulating fluidised beds is the absence of distinct temperature and reaction zones. The fluidised bed consists of an inert bed material. This thus ensures that the individual partial reactions take place simultaneously, as well as a uniform temperature (approximately 800° C.). The method is almost pressureless (up to a maximum of 0.5 bar) and can therefore be carried out in a problem-free manner from a technical point of view. It is characterised by high cost-effectiveness. The initial costs are lower than those of the aforesaid types of gasifier.

The starting point for further utilisation as a fuel is the medium-calorific gas from the bio-synthesis gas plant (on the basis of renewable raw materials), which, after removing dust and washing out condensable hydrocarbons (oil quenching), can be compressed to approximately 20 bar by means of a turbocompressor and refined by the following process steps:
gas purification and CO₂ removal by means of a rectisol plant
optimisation of the H₂ to CO ratio by means of the shift method
Fischer-Tropsch synthesis
discharge to a preferred hydrocracker/production diesel with a very high cetane number.

It can consequently be stated that the method according to the invention is capable of producing 23 t high-quality fuel from 100 t biomass on the basis of the synthesis gas.

The method according to the invention and the corresponding devices necessitate the purification of the synthesis gas produced in order to utilise it as energy in the specially developed pulse heaters (including pilot burners). The system is based on the “in-situ removal” of the harmful gas components in the reaction chamber of the steam converter or directly in the corresponding gas section.

The harmful (sulphur-containing) components to be removed from the product gas are released directly during the gasification process. An essential part of the method described here is the direct chemical bonding of the latter with the components released from the feed by the addition of the adsorbent to the gasification reactor. This direct adsorption immediately after the release of the harmful components is referred to as “in-situ” gas purification (or desulphurisation in the case of the removal of sulphur-containing components). The sulphur components in question are therefore adsorbed directly at the point of production, i.e. in the reaction zone of the gasification by means of the additive (virtually during production), the sulphur (or the homologues selenium and tellurium) thus reacting to form sulphides, or selenides and tellurides. This method of procedure is known from applications in combustion processes and similar gasification methods (Lit.: 6; 7). Similar processes for other combustion and gasification processes have been described in the relevant literature. In a first step, the aim is to remove the sulphur-containing gas components (mainly H₂S) with the aid of additives such as limestone, dolomite or similar prepared or naturally occurring additives.

In addition to the removal of sulphur-containing components, this method can also be used for the substances Se (selenium) and Te (tellurium) from the same main group of the periodic table accompanying the sulphur.

Tests with these methods have shown that, in the case of the reaction temperatures prevailing in the steam cracker, the harmful substances sulphur, tellurium and selenium are separated off directly with high efficiency as a result of the thermodynamic stability, while the adsorption of chlorine requires more reactive adsorbents and adaptation to the reaction temperatures. The harmful gas components forming (in situ) during the conversion of the feed are transported to the adsorbent particle at the solid particles of the adsorbents in the form of a two-phase reaction (gas-solid reaction) by convection and diffusion of the harmful substance, where they react to form a thermodynamically stable salt. These particles are extracted together with the ash or are partly separated off in the downstream gas purification stages in the gas path, in particular in the multi-cyclone and the sintered metal fine filters, where they are selectively extracted.

In the second step, the object is the absorption or removal of chlorine present in the form of the chlorine radical and originating from organic chlorine compounds. Other chlorine compounds (e.g. chlorine salts, chlorides) are less relevant from the point of view of the method according to the invention.

The method can be extended to the group consisting of halogens (Cl, I, Br, F) in accordance with the thermodynamic properties of the individual components.

The absorbents or reactants are introduced at the most suitable point for the respective function according to the process. In addition to direct addition either as an additive to the feed or direct metered addition to the steam converter, injection into the external cyclone also is suitable, particularly in order to find suitable reaction conditions for chlorine absorption.

The metered addition of additives is generally controlled either by means of ratio control with a variable ratio of feed and additive or by means of trim back control, the reference variable reflecting the concentration of harmful substances measured in the synthesis gas.

The separation of the dust content as a further step in the synthesis gas makes particular demands on the separation of the extremely fine dust having a high carbon content. According to the method of the invention, intermediate cooling to temperatures of between 150 and 700° C. (above the dew point of the synthesis gas) is followed by dust removal in a multi-cyclone and a downstream battery of sintered metal filters.

This gas purification stage (dust removal) consists of a multi-cyclone forming a preliminary purification stage and a downstream filter unit. The multi-cyclone consists of a battery of small cyclones mounted on a supporting plate in a housing. The incoming product gas (which contains dust and adsorbent) is distributed in a virtually uniform manner to the individual elements of the multi-cyclone in accordance with the flow resistance. A partial dust stream (together with the adsorbent) is separated off in these elements. The gas leaves the apparatus and the dust accumulates together with the adsorbent also separated off in the hopper of the apparatus, from where the substances separated off are extracted.

The second stage of this hot gas purification and dust removal consists of fine filters with sintered metal candles. A filter cake consisting of the dust content and loaded adsorbent content not separated off in the multi-cyclone stage forms there at the candles, thereby resulting not only in dust separation, but also, in particular, in the separation of harmful chlorine-containing substances without any significant increase in the adsorption of harmful substances. It is moreover possible to add adsorbent to this region once again in a specific metered manner. The layer thickness and the low flow rate of the cake are crucial parameters here.

### DESCRIPTION OF THE FIGURES

The FIGURE serves to describe the course of the method and for a clearer understanding of the following detailed description of the preferred embodiment.

FIG. 1 shows the purification stages in a gasifier operated with pulse heaters.

### PREFERRED EMBODIMENT

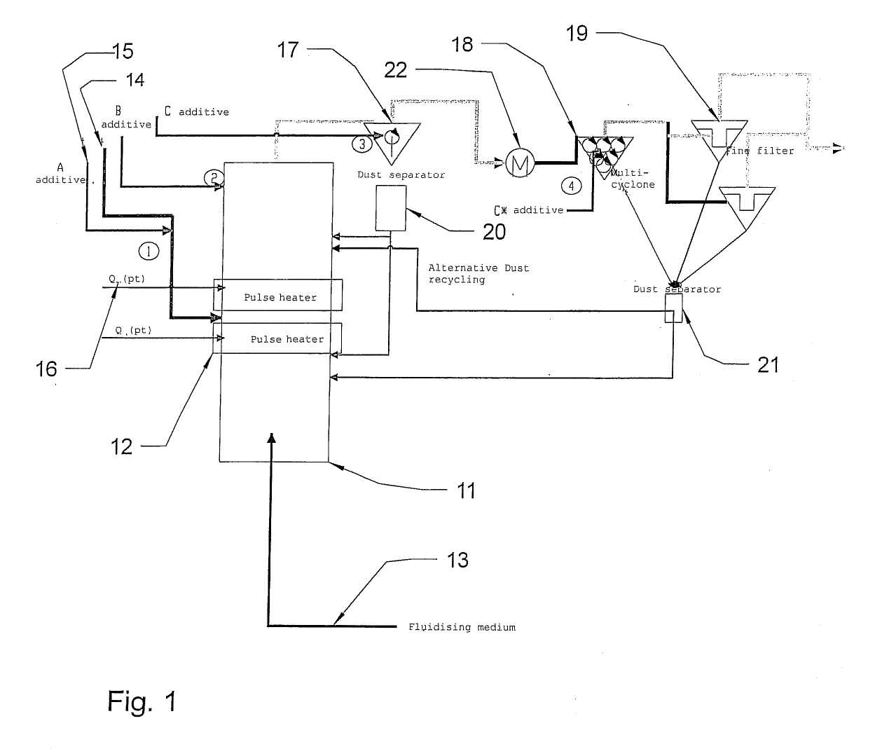

FIG. 1 shows a gasifier 11 with pulse heaters 12 arranged in the central region of the gasifier 11 in order to form a preferably stationary fluidised bed in this region. The number of pulse heaters can be varied. Both one and two or more are conceivable.

Steam is introduced into the gasifier as an oxidising and fluidising medium 13. Other fluidising media, such as synthesis gas or CO₂, are also conceivable. Feed 14 is furthermore introduced in the region of the pulse heaters 12. This feed can be biomass and other substances, such as lignite or secondary raw materials (such as municipal solid waste, sewage sludge, waste from the food industry, etc.). The biomass is gasified in the fluidised bed consisting of inert bed material at a temperature in the region of approximately 800° C.

The pulse heaters are operated at Q(pt). Q(pt) means heat flow and refers to the reaction enthalpy (i.e. the calorific value) of the fuel gas used. In addition to the synthesis gas produced in the reformer (product gas), many different fuel gas streams (from propane to natural gas and similar gases) can also be used as the fuel gas, as a result of which, particularly in a combined plant, this pulse heater can be used for the combustion of what are referred to as off-gases produced, so to speak, as by-products during synthesis, such as methanol synthesis, and therefore helps to increase the efficiency of an entire plant.

This fuel gas is produced as a branch of the natural production during normal operation, i.e. refining the biomass to form a new product: (medium-calorific) heating gas.

For a first purification step for the removal of sulphur-containing gas components, preferably H₂S, additives are added to the feed 14, wherein these may be calcium carbonate, limestone, dolomite or the like. They are added directly in the region 1 of the pulse heaters or to the fluidised bed or are mixed with the feed before it is introduced into the fluidised bed. Alternatively, they can also be added directly to the reactor in the form of calcium carbonate, limestone, calcium hydroxide or the like 2. The additive is in this case preferably added directly in the upper region of the reactor.

In a further step, chlorine, present in the form of the chlorine radical and generally originating from organic chlorine compounds, is absorbed or removed by means of further additives. These further additives are preferably calcium hydroxide or the like. These additives 3, 4 are preferably injected into the dust separator 17 or the multi-cyclone. It is of course also conceivable for them to be injected directly into the reactor 11 or added to the feed 14.

The addition of the additives is controlled either by means of ratio control with a variable ratio of feed and additive or by means of trim back control, reference variables in the synthesis gas being measured by means of sensors so that conclusions can then be drawn about the harmful substances.

The dust content is separated off in a further step. Various filters and separators are connected in series. Their residues are once again recycled to the reactor. Recycling can be effected at various points, i.e. below the pulse heaters, above the pulse heaters or directly into the bed of the burners. Cyclones 17 and multi-cyclones 18, as well as filters, in particular, fine filters 19, which can be designed as a downstream battery of sintered metal filters, are preferably used. In a first step, one cyclone 17 is arranged downstream, wherein recycling can be effected below or above the pulse heaters by means of a dust separator 21.

Intermediate cooling to temperatures of between 150 and 700° C. (above the dew point of the synthesis gas) is then preferably effected in a cooler 22, to be followed by purification in a multi-cyclone in the cooled state.

The additives calcium hydroxide or the like can be added both to the cyclone 17 and to the multi-cyclone 18.

The synthesis gas is then fed to a row of fine filters 19 arranged in parallel or in series.

The residues from the fine filters and the multi-cyclone are collected in a dust separator 21 and fed back to the reactor at various points, as already described hereinabove. The dust separated off can thus be added above or below the pulse heaters.

The Figs. show the addition of additives together with feed in 1, the addition of additives directly to the reactor in 2, further the addition of additives to H “hot” cyclone in 3. Further the addition of additive to multi-cyclone is show under 4. A stands for additive consisting of calcium carbonate, limestone, dolomite or the like. B stands for additive consisting of calcium carbonate, limestone, calcium hydroxide or the like. C, C* stands for additive consisting of calcium hydroxide or the like. The reactor, gasifier is 11, the pulse heater 12, a fluidising medium 13, a feed 14, additives 15, Q(pt) is 16, cyclone is 17, multi-cyclone is 18, fine filter is 19, dust separator is 20, 21, and the cooler/heat exchanger is 22.

The detailed description intendeds not to limit the scope of protection. The description shows only a possible embodiment of the invention. The claims define the scope and the spirit of the invention.

1. Method for the process-integrated gas purification of a synthesis gas, including the following steps:
Gasification of the feed in a reactor by the use of pulse heaters;
Adding of additives to the reactor or to the gas section downstream of the reactor in order to remove sulphur-containing gas components in order to achieve in-situ removal;
Separating of dust content of the synthesis gas in the downstream gas section;
recycling of the dust content separated off to the reactor.

2. The method according to claim 1, including a further step in which additives are added to the reactor or to the gas section downstream of the reactor in order to remove chlorine.

3. The method according to claim 2, in which the additives for removing chlorine are added to one or more downstream cyclones.

4. The method according to claim 3, in which the additives are introduced both into a cyclone in which the synthesis gas is not yet substantially cooled and into a second cyclone once the synthesis gas has been cooled.

5. The method according to claim 4, in which intermediate cooling to temperatures of between 150 and 700° C., in particular above the dew point of the synthesis gas, is effected in a cooler.

6. The method according to claim 1, in which the chlorine is removed by injecting calcium hydroxide or similar substances as an additive.

7. The method according to claim 1, in which the sulphur-containing gas components are removed with additives including one or more of the following: calcium carbonate, limestone, dolomite, calcium hydroxide or similar substances.

8. The method according to claim 1, in which the additives for removing the sulphur-containing gas components are added at one or more of the following points: to the feed, directly into the region of the pulse heater, above the pulse heater.

9. The method according to claim 1, in which at least one pulse heater is arranged in the central region of the reactor in order to form a preferably stationary fluidised bed in this region.

10. The method according to claim 1, in which the dust content is separated off by means of cyclones or multi-cyclones and fine filters connected in series, the residues from which are recycled to the reactor preferably by means of a dust separator.

11. The method according to claim 10, in which cooling of the synthesis gas is effected between the purification operations in the cyclones.

12. The method according to claim 1, in which the recycling of the dust content separated off is effected at one or more points in the reactor, including: below the pulse heater, above the pulse heater or directly into the bed of the pulse heater.

13. Device for the process-integrated gas purification of a synthesis gas, including the following components:
reactor with at least one pulse heater in which feed is gasified;
means for feeding additives to the reactor or to the gas section downstream of the reactor in order to remove sulphur-containing gas components in order to achieve in-situ removal;
separator in the downstream gas section in order to separate off dust content of the synthesis gas;
means for recycling the dust content separated off to the reactor.

14. The device according to claim 13, including feed means for adding additives to the reactor or to the gas section downstream of the reactor in order to remove chlorine.

15. The device according to claim 14, in which the feed means are arranged in such a manner that the additives for removing chlorine are added to one or more downstream cyclones.

16. The device according to claim 15, in which a cooling device is arranged between two cyclones so that the additives are introduced both into a cyclone in which the synthesis gas is not yet substantially cooled and into a second cyclone once the synthesis gas has been cooled.

17. The device according to claim 16, in which the cooling device carries out intermediate cooling to temperatures of between 150 and 700° C., in particular above the dew point of the synthesis gas.

18. The device according to claim 13, in which the feed means injects calcium hydroxide or similar substances as an additive in order to remove chlorine.

19. The device according to claim 13, in which the feed means introduces additives for removing the sulphur-containing gas components including one or more of the following: calcium carbonate, limestone, dolomite, calcium hydroxide or similar substances.

20. The device according to claim 13, in which the feed means introduces additives for removing the sulphur-containing gas components at one or more of the following points: in the region of the introduction of the feed, directly in the region of the pulse heater, above the pulse heater.

21. The device according to claim 13, in which at least one, preferably several pulse heaters are arranged in the central region of the reactor in order to form a preferably stationary fluidised bed in this region.

22. The device according to claim 13, in which the dust content is separated off by means of cyclones or multi-cyclones and fine filters connected in series, the residues from which are recycled to the reactor preferably by means of a dust separator.

23. The device according to claim 13, in which the means are provided to allow the dust content separated off to be recycled at one or more points in the reactor, including: below the pulse heater, above the pulse heater or directly into the bed of the pulse heater.
